(19) United States
(12) Patent Application Publication
(10) Pub. No.: US 2024/0202769 A1
(43) Pub. Date: Jun. 20, 2024

(54) METHOD, APPARATUS, DEVICE, STORAGE MEDIUM AND PROGRAM PRODUCT FOR PROMOTER DETERMINATION

(71) Applicant: Beijing Youzhuju Network Technology Co., Ltd., Pinggu District, Beijing (CN)

(72) Inventors: Songsong LI, Beijing (CN); Xu Zhao, Beijing (CN); Siyuan Feng, Beijing (CN); Enlu Lin, Beijing (CN); Jun Zhang, Beijing (CN)

(21) Appl. No.: 18/555,100

(22) PCT Filed: Apr. 7, 2022
(86) PCT No.: PCT/CN2022/085597

§ 371 Date: Oct. 12, 2023

(30) Foreign Application Priority Data
Apr. 30, 2021 (CN) 202110484423.5

(51) Int. Cl. G06Q 30/0242

(52) U.S. Cl. CPC G06Q 30/0243

(57) ABSTRACT

According to the embodiments of the present disclosure, a method, an apparatus, a device, a storage medium and a program product for promoter determination are provided. The method includes: recalling, from a set of promoters, a plurality of candidate promoters for a target provider, the target provider being capable of providing at least one object available to a user, the plurality of candidate promoters being capable of publishing guidance contents for guiding a user to acquire a corresponding object; determining, based on a first feature of the target provider and second features of the plurality of candidate promoters, priority levels of the plurality of candidate promoters; and determining, based on the priority levels, a target promoter for the target provider from the plurality of candidate promoters.

### CROSS-REFERENCE TO RELATED APPLICATIONS

The present application claims priority to Chinese Patent Application No. 202110484423.5, titled “Method, apparatus, device, storage medium and program product for promoter determination,” filed on Apr. 30, 2021, the contents of which are hereby incorporated by reference in their entirety.

### TECHNICAL FIELD

Various embodiments of the present disclosure relate to the field of computers, and in particular to a method, an apparatus, a device, and a computer storage medium for entity clustering.

### BACKGROUND

With the development of information technology, people may encounter various guidance contents in their daily lives, for example, texts, video advertisements, live streaming for selling goods, or the like. These guidance contents may guide people to acquire corresponding objects. Such objects, for example, may comprise tangible goods, digital contents, specific services, or the like.

Some providers (for example, stores or service providers, and so on) cooperate with promoters to promote better understanding of objects by users or guide more users to acquire these objects. However, for a provider, a significant amount of time and manpower costs are needed to select a suitable promoter that meets its needs from a large number of promoters. Therefore, how to effectively provide a suitable promoter to a provider has become a focus of attention.

### SUMMARY

In a first aspect of the present disclosure, a method of promoter determination is provided. The method comprises recalling, from a set of promoters, a plurality of candidate promoters for a target provider, the target provider being capable of providing at least one object available to a user, the plurality of candidate promoters being capable of publishing guidance contents for guiding a user to acquire a corresponding object; determining, based on a first feature of the target provider and second features of the plurality of candidate promoters, priority levels of the plurality of candidate promoters; and determining, based on the priority levels, a target promoter for the target provider from the plurality of candidate promoters.

In a second aspect of the present disclosure, an apparatus for promoter determination is provided. The apparatus comprises a recalling unit configured to recall, from a set of promoters, a plurality of candidate promoters for a target provider, the target provider being capable of providing at least one object available to a user, the plurality of candidate promoters being capable of publishing guidance contents for guiding a user to acquire a corresponding object; a sorting unit configured to determine, based on a first feature of the target provider and second features of the plurality of candidate promoters, priority levels of the plurality of candidate promoters; and a determining unit configured to determine, based on the priority levels, a target promoter for the target provider from the plurality of candidate promoters.

In a third aspect of the present disclosure, an electronic device is provided. The electronic device comprises a memory and a processor, the memory is used to store one or more computer instructions, and the one or more computer instructions are executed by the processor to implement the method of the first aspect.

In a fourth aspect of the present disclosure, a computer-readable storage medium is provided. The computer-readable storage medium stores thereon one or more computer instructions, which are executed by a processor to implement the method of the first aspect.

In a fifth aspect of the present disclosure, a computer program product is provided. The computer program product comprises one or more computer instructions, wherein the one or more computer instructions are executed by a processor to implement the method of the first aspect.

According to various embodiments in the present disclosure, it is possible to efficiently select, from a plurality of recalled candidate promoters, a promoter that meets a target provider's needs based on information of a historical promoter that the target provider has cooperated with and the historical providers that the candidate promoters have cooperated with.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which multiple embodiments of the present disclosure can be implemented;

FIG. 2 illustrates a flowchart of an example process for promoter determination according to some embodiments of the present disclosure;

FIG. 3 illustrates a flowchart of an example process for recalling candidate promoters according to some embodiments of the present disclosure;

FIG. 4 illustrates a schematic structural block diagram of an apparatus for promoter determination according to some embodiments of the present disclosure; and

FIG. 5 illustrates a block diagram of a computing device capable of implementing multiple embodiments of the present disclosure.

### DETAILED DESCRIPTION

The embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

As discussed above, an increasing number of providers expect to guide a user to acquire an object that is provided by the providers through cooperation with promoters. For example, some merchants may cooperate with some live streamers and guide users to purchase products sold by the merchants through contents of live streaming.

However, with the rapid development of the live streaming industry, in order to promote products, merchants usually have to spend a large amount of time selecting a suitable live streamer from a large number of live streamers. This will consume merchants a significant amount of time and labor costs.

It can be seen that it is difficult for current solutions to effectively determine a promoter that meets a provider's needs for the provider.

In order to at least partially address one or more of aforementioned issues and other potential issues, example embodiments of the present disclosure propose a scheme for promoter determination. Overall, according to the embodiments described herein, a plurality of candidate promoters (for example, live streamers, video creators, text content creators, and so on.) for a target provider (for example, a physical store, a virtual store, a service provider, and so on. that is capable of providing available physical objects or entities of virtual objects to users) may be recalled from a set of promoters. The target provider can provide at least one object (for example, a tangible good, a digital content, or a specific service) that is available to users (for example, followers of a live streamer, students or parents participating in a training, viewers of a video, readers of an article, and so on), and the plurality of candidate promoters can publish guidance contents (for example, live streaming contents, video files, online articles, and so on) to guide a user to acquire corresponding objects.

Subsequently, priority levels of the plurality of candidate promoters may be determined based on a first feature of the target provider and second features of the plurality of candidate promoters, and the target promoter for the target provider may be determined from the plurality of candidate promoters based on the priority levels. According to the embodiments of the present disclosure, a promoter that better meets the needs of the target provider may be more efficiently determined.

Reference will be made to the accompanying drawings to provide details of embodiments of the present disclosure.

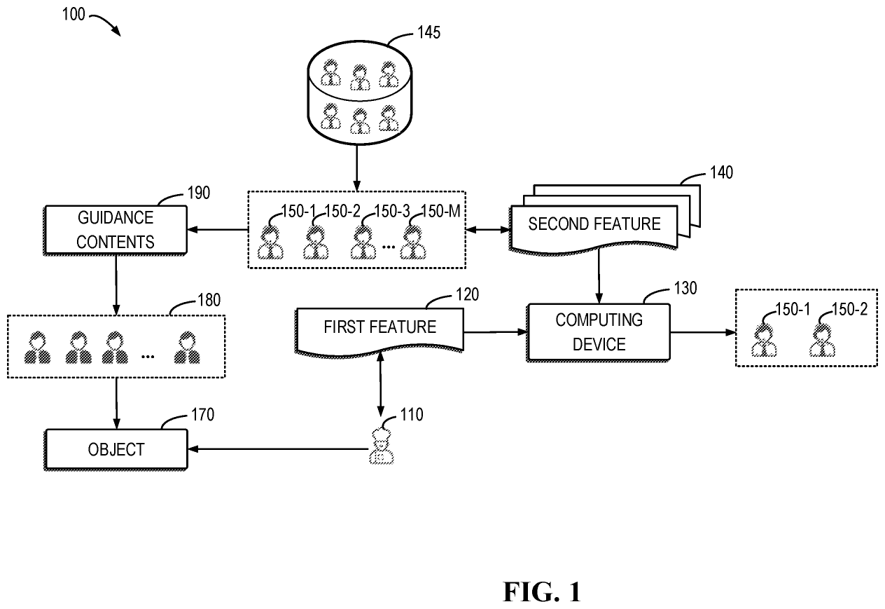

FIG. 1 illustrates a schematic diagram of an example environment 100 that can be implemented in multiple embodiments of the present disclosure. In this example environment 100, a computing device 130 recalls a plurality of candidate promoters 150-1, 150-2, to 150-M (individually or collectively referred to as candidate promoters 150) for a target provider 110 from a set of promoters 145. As discussed above, the target provider 110 may provide at least one object 170 (for example, tangible goods, digital content, or specific services) that is accessible to a user 180. Such a target provider 110 may include any individual or organization capable of providing the object 170. For example, an example target provider 110 may include but is not limited to: a physical or virtual store for selling goods, a news service provider providing news subscription services, a restaurant providing catering services, and a music service provider providing music services, and so on.

The set of promoters 145 may include a plurality of promoters capable of publishing guidance contents. As discussed above, the promoter may be any individual or organization capable of providing guidance contents 190 for guiding the user 180 to acquire corresponding object. For example, an example promoter may include but is not limited to: a live streamer for selling products, an author that writes restaurant reviews, a radio program host that provides music sharing contents, a creator that publishes video works, and so on. Taking a live streaming sales platform as an example, the set of promoters 145 may include all live streamers capable of undertaking sales services. The process of recalling the plurality of candidate promoters 150 from the set of promoters 145 will be described in detail below and will not be discussed in detail here.

As shown in FIG. 1, after recalling to acquire the plurality of candidate promoters 150, the computing device 130 may determine the priority levels of the plurality of candidate promoters based on a first feature 120 of the target provider 110 and second features 140 of the plurality of candidate promoters 150. The first feature 120, for example, may be used to characterize the target provider 110 or the at least one object 170 provided by or a first provider. The second features 140, for example, may be used to characterize the candidate promoters 150 or the guidance contents 190 published by the candidate promoters 150. The process of determining the priority levels based on the first feature 120 and the second features 140 will be described in detail below and will not be discussed in detail at here.

The computing device 130 may further determine the target promoter (for example, the promoters 150-1 and 150-2) for the target provider 110 from the recalled plurality of candidate promoters 150 based on the determined priority levels. For example, the computing device 130 may select a candidate promoter with the priority level exceeding a threshold level from the plurality of candidate promoters 150 to be a target promoter. Alternatively, the computing device 130 may select a predetermined number of target promoters with higher priority levels according to a ranking of the priority levels.

It should be understood that the numbers of candidate promoters and target promoters shown in FIG. 1 are only described for purpose of illustration, without suggesting any limitations to the present disclosure.

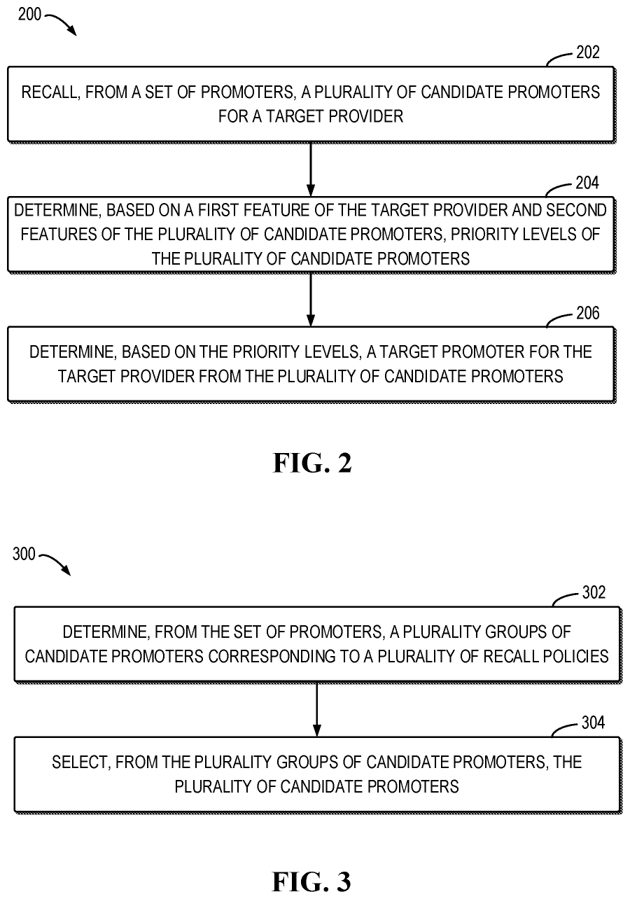

The process of determining the target promoter by the computing device 130 will be described in detail below with reference to FIG. 2. FIG. 2 illustrates a flowchart of an example process 200 for determining a promoter according to some embodiments of the present disclosure. This process 200 may be implemented, for example, at the computing device 130 in FIG. 1. For the sake of convenience, the process 200 will be described below with reference to a scenario of a merchant and a live streamer. It should be understood that the process 200 may also be applied to other appropriate providers or promoters.

As shown in FIG. 2, at block 202, the computing device 130 recalls, from a set of promoters 145, the plurality of candidate promoters 150 for a target provider 110. The target provider 110 is capable of providing at least one object 170 available to a user 180. The plurality of candidate promoters 150 are capable of publishing guidance contents 190 for guiding a user to acquire a corresponding object. In the present disclosure, “recall” refers to the process of selecting the plurality of candidate promoters 150 from the set of promoters 145.

Taking live streaming sales as an example, the computing device 130 may recall to acquire a plurality of candidate live streamers from a set of live streamers in response to a request of a target merchant. For example, the computing device 130 may initiate a recall of candidate live streamers in response to the target merchant logging into a live streamer acquisition page. Alternatively, the computing device 130 may determine that there is a need for the target merchant to cooperate with a live streamer in response to listing new goods by the target merchant, thereby automatically initiating a recall of candidate live streamers.

In some embodiments, the computing device 130 may recall the plurality of candidate promoters 150 from the set of promoters 145 using one or more predetermined recall policies. In some embodiments, to enrich the results, the computing device 130 may recall the plurality of candidate promoters 150 using a combination of a plurality of recall policies. The detailed process of recalling target promoters will be described below with reference to FIG. 3. FIG. 3 illustrates a flowchart of an example process 300 of recalling promoters according to some embodiments of the present disclosure.

As shown in FIG. 3, at block 302, the computing device 130 may determine, from the set of promoters 145, a plurality groups of candidate promoters corresponding to a plurality of recall policies.

In some embodiments, the computing device 130 may utilize a Field-aware Factorization Machines FFM recall policy for recall. Specifically, the computing device 130 may determine a first field vector of the target provider 110 and a second field vector of the plurality of candidate promoters 150 using the trained FFM model, and determine a group of candidate promoters base on a distance between the first field vector and the second field vector.

In some embodiments, the FFM model may be trained, for example, based on cooperation information of the provider and the promoter, so that the provider and the promoter that have cooperated with each other have a closer distance in a vector space. On the contrary, the provider and the promoter that have not cooperated with each other have a farther distance in the vector space. In this way, the computing device 130 may find a promoter that is closer to the first field vector of the target provider 110 in the vector space to be a candidate promoter.

In other embodiments, the computing device 130 may utilize a collaborative recall policy for recall. Specifically, the computing device 130 may determine, based on historical cooperation information of the target provider 110, a historical promoter that has cooperated with the target provider. Subsequently, the computing device 130 may acquire a group of candidate promoters whose differences from the historical promoter are below a predetermined threshold.

Taking the live streaming sales as an example, the computing device 130 may determine a historical live streamer that the target merchant has previously cooperated with, and recall live streamers similar to the historical live streamer to be candidate live streamers. For example, in a case that the target merchant has previously cooperated with a first live streamer in a beauty industry, the computing device 130 may recall a second live streamer that is also in the beauty industry and has a similar size of followers.

It should be understood that appropriate methods may be used to determine the differences between promoters. Taking the live streamer as an example, differences may be determined based on attribute information (for example, a sales category, live streaming duration, and so on) of the live streamer. Alternatively, differences between live streamers may be determined based on the attribute information of their followers, for example a number of followers or a distribution of follower attributes.

Based on this approach, other promoters similar to the historical promoter that has cooperated with the target provider 110 may be recalled.

In some embodiments, the computing device 130 may utilize a contact establishment recall policy for recall. Specifically, the computing device 130 may determine, based on historical contact information of the target provider 110, a promoter that has previously been contacted by the target provider 110, to be a group of candidate promoters.

Taking the live streaming sales as an example, the computing device 130 may acquire live streamers that have previously contacted by the target merchant on the platform, and recall such live streamers as candidate live streamers. It should be understood that such live streamers may be those that have previously cooperated, or may be those that have only contacted but have not cooperated.

In some embodiments, the computing device 130 may utilize a lookalike recall policy for recall. Specifically, the computing device 130 may determine, based on a group of seed users associated with the target provider, a group of expanded users. The group of seed users acquires an object provided by the target provider within a predetermined period of time. Subsequently, the computing device 130 may acquire a promoter associated with the group of expanded users to be a group of candidate promoters.

Taking the live streaming sales as an example, the computing device 130 may take users that have previously purchased a good from the target merchant as a positive sample, i.e., seed users, and take users that clicked but did not purchase as a negative sample to construct a seed population learning model for the merchant. Correspondingly, the computing device 130 may determine a group of expanded users from the users of the live streaming sales platform using the population learning model. Such expanded users, for example, also have the potential to purchase goods from the target merchant.

Furthermore, the computing device 130 may acquire a group of candidate live streamers based on the live streamers subscribed by such expanded users, live streamers that such expanded users have watched their live streaming, and live streamers that such expanded users have purchased products via their live streaming.

In some embodiments, the computing device 130 may utilize a popularity recall policy for recall. Specifically, the computing device 130 may determine a group of candidate promoters with a popularity exceeding a threshold. The popularity indicates a degree to which the promoter is concerned by a user.

Taking the live streaming sales as an example, the computing device 130 may recall a predetermined number of live streamers which are most popular on the platform to be candidate live streamers. It should be understood that such popularity may be determined based on, for example, the number of followers, a number of users watching live streaming, the number of users that have successfully purchased, and support from users for the live streamer (for example, a number of likes, a number of reposts, a number of comments, a number of gifts, and so on.).

In some embodiments, the computing device 130 may utilize a similar object recall policy for recall. Specifically, the computing device 130 may determine a group of similar objects whose differences from the at least one object 170 are below a predetermined threshold; and acquire a promoter associated with the group of similar objects to be a group of candidate promoters.

Taking the live streaming sales as an example, the computing device 130 may determine a group of products that are currently for sale by the target merchant and determine a group of similar products based on the similarity between the products. For example, the target merchant may be currently selling beauty products from brand A, and the computing device 130 may determine beauty products from brand B that are close in price to the beauty products. Subsequently, the computing device 130 may recall live streamers that have advertised the group of similar products to be candidate live streamers. For example, the computing device 130 may recall live streamers whose number of advertised beauty products from brand B exceeds a threshold within a predetermined period of time in the past to be candidate live streamers.

It should be understood that one or more of the aforementioned example recall policies may be used to recall the plurality groups of candidate promoters.

At block 304, the computing device 130 may select, from the plurality groups of candidate promoters, the plurality of candidate promoters 150.

In some embodiments, because a number of target promoters provided to the target provider 110 are usually limited, the computing device 130, for example, may select the plurality of candidate promoters 150 from the plurality groups of candidate promoters to reduce computational burden.

In some embodiments, in order to ensure the variety of recall results, the computing device 130 may use snake-shaped merging to select up to a predetermined number of candidate promoters 150 from the plurality groups of candidate promoters.

For example, when using 4 recall policies to acquire 4 groups of candidate promoters, the computing device 130 may select one candidate promoter from the 4 groups of candidate promoters to serve as a plurality of recalled candidate promoters 150.

In some embodiments, considering that the results of different recall policies may be duplicated, the computing device 130 may also constrain individual candidate promoter, for example, to cause at most a threshold number of candidate promoters in each group of candidate promoters to be included in the plurality of selected candidate promoters.

In some embodiments, considering that some promoters may have a weaker willingness to cooperate with other providers, the computing device 130 may also filter out self-broadcasting promoters. Specifically, the computing device 130 may exclude a self-broadcasting promoter from the plurality groups of candidate promoters to acquire the plurality of candidate promoters, where the self-broadcasting promoter guides a user to acquire an object that is provided by the self-broadcasting promoter or an affiliate party of the self-broadcasting promoter within a predetermined period of time.

Taking the live streaming sales as an example, such a self-broadcasting promoter may refer to a self-broadcasting live streamer, whose products of live streaming sales in a past month were all sold by the self-broadcasting live streamer or by an affiliate party (for example, an affiliate company) of the self-broadcasting live streamer. Such a self-broadcasting live streamer usually have weak willingness to cooperate, and filtering out such a self-broadcasting live streamer may avoid providing live streamers with lower willingness to cooperate to the target merchant.

The above introduces the process of recalling the plurality of candidate promoters 150 from the set of promoters 145. Continuing with reference to FIG. 2, at block 204, the computing device 130 determines, based on the first feature 120 of the target provider 110 and the second features 140 of the plurality of candidate promoters 150, priority levels of the plurality of candidate promoters.

In some embodiments, the first feature may represent a user attribute of a first group of associated users associated with the target provider 110, and the second feature represents a user attribute of a second group of associated users associated with the candidate promoter.

Taking the live streaming sales as an example, the first feature may represent, for example, relevant attributes of a purchased user that has purchased the goods sold by the target merchant. Correspondingly, the second features may represent, for example, relevant attributes of a group of followers that have followed the candidate live streamer.

In some embodiments, the first feature may represent first statistical information associated with the target provider, the second feature represents second statistical information associated with the candidate promoter. At least one of the first statistical information and the second statistical information is updated in real-time or periodically in response to a user operation.

Taking the live streaming sales as an example, the first statistical information associated with the target merchant may include, for example, real-time updated data, such as sales revenue of the target merchant, a number of positive user reviews, a number of negative user reviews, a number of product views, a number of times a product was added to a shopping cart, and so on. The computing device 130 may utilize, for example, a predetermined event tracking point to enable a specific user operation to trigger real-time updates of the first statistical information. On the other hand, the first statistical information, for example, may also be updated periodically. For example, the first statistical information may indicate the sales revenue of the target merchant in the past 30 days, a total number of user reviews in the past 30 days, and so on. Such statistical information, for example, may be updated regularly by the platform on a daily basis.

Correspondingly, the second statistical information may also include some real-time updated data, for example a total amount of goods advertised by candidate live streamers, the number of followers, and so on. The computing device 130, for example, may utilize a predetermined event tracking point to enable a specific user operation to trigger real-time updates of the second statistical information.

On the other hand, the second statistical information, for example, may be updated periodically. For example, the second statistical information may indicate sales volume of the candidate live streamer in the past 30 days, a number of new followers in the past 30 days, and so on. Such statistical information, for example, may be updated regularly by the platform on a daily basis.

In some embodiments, the first feature represents a first attribute of a historical promoter that has cooperated with the target provider, and the second feature represents a second attribute of a historical provider that has cooperated with the candidate promoter. Such first attribute and second attribute aim to describe characteristics of promoters that the target provider has previously cooperated with, and characteristics of providers that the candidate promoters have previously cooperated with.

The specific information that the first feature 120 and the second features 140 may represent is discussed above. In some embodiments, in order to determine the priority level, the computing device 130 may generate input features based on a first feature representation of the first feature 120 and a second feature representation of the second features 140.

In some embodiments, the computing device 130, for example, may cascade the first feature representation and the second feature representation to acquire the input features. Such feature representations may include, for example, a feature part corresponding to the user attribute of an associated user, a feature part corresponding to the statistical information, and/or a feature part corresponding to an attribute of a historical cooperator. Based on this approach, the target provider 110 and the plurality of candidate promoters 150 may be characterized more comprehensively.

Furthermore, the computing device 130 may utilize a priority model to process input features to determine the priority levels, where the priority model is trained based on historical cooperation information between a group of training providers and a group of training promoters.

In some embodiments, the computing device 130 may acquire a trained priority model. Such priority model may be implemented through an appropriate machine learning model (for example, a deep neural network). It should be understood that the priority model may be trained by a same training device as the computing device 130 or a different training device from the computing device 130.

During the training process, a training device may acquire a group of training providers and a group of training promoters, and construct a plurality of provider-promoter sample pairs. For each sample pair, the training device may determine the input features input to the model based on the aforementioned methods, and train the priority model based on a true value of the model training. Whether the provider-promoter have previously cooperated serves as the true value (for example, 1 may indicate that the provider-promoter have cooperated, 0 may indicate that the provider-promoter have not cooperated).

After this training process, the trained priority model can receive input features and input a 0-1 probability to represent a probability of cooperation between the target provider 110 and the candidate promoter 150. For example, this probability may be determined as the priority level of the candidate promoter.

Continuing with reference to FIG. 2, at block 206, the computing device 130 may determine the target promoter for the target provider from the plurality of candidate promoters based on the priority levels.

In some embodiments, the computing device 130 may select a candidate promoter with the priority level exceeding a threshold level from the plurality of candidate promoters 150 to be a target promoter. Alternatively, the computing device 130 may select a predetermined number of target promoters with higher priority levels according to a ranking of the priority levels.

In some embodiments, the computing device 130 may also adjust the priority level of at least one candidate promoter before sorting to acquire a final target promoter, and determine the target promoter based on the adjusted priority level.

In some embodiments, considering that the target provider 110 may have a higher expectation of cooperating with a new promoter, the computing device 130 may reduce the priority level of at least one candidate promoter that has previously cooperated with the target provider.

In some embodiments, the computing device 130 may determine, based on first guidance information of the at least one candidate promoter, a degree by which the priority level is reduced. The first guidance information indicates an amount of objects acquired via a guidance content published by the at least one candidate promoter within a predetermined period of time. Furthermore, the computing device 130 may reduce the priority level based on the degree.

Taking the live streaming sales as an example, the first guidance information, for example, may indicate sales volume of the previously cooperated live streamer for the target merchant. Correspondingly, the larger the sales volume of the live streamer, the closer the contact between the target merchant and the live streamer, and the computing device 130 may no longer provide the live streamer additionally.

In some embodiments, the computing device 130 may further calculate, for example, the proportion of the live streamer's sales volume to the target merchant's sales volume through the live streamer, and determine a degree by which the priority level should be lowered based on the proportion. For example, the priority level of a live streamer with a larger proportion may be reduced to a greater extent. On the contrary, the priority level of a live streamer with a smaller proportion may be reduced to a smaller extent.

In some embodiments, the computing device 130 may further determine a difference between first evaluation information of the plurality of candidate promoters and second evaluation information of a historical promoter. The historical promoter comprises a promoter that has previously cooperated with the target provider. Furthermore, the computing device 130 may further adjust the priority level based on the difference such that a priority level of a candidate promoter with a difference greater than a threshold is reduced.

Taking the live streaming sales as an example, the first evaluation information may include, for example, a level of a candidate live streamer on the platform, and the second evaluation information may include, for example, levels of historical live streamers that the target merchant has previously cooperated with. Generally speaking, the levels of live streamers that merchants are willing to cooperate with are relatively stable. For example, larger stores are generally unwilling to cooperate with lower level live streamers, while smaller stores are generally difficult to pay for potential cooperation fees that may arise from higher level live streamers. Based on this approach, provided results can be more in line with expectations of the merchant.

In some embodiments, the computing device 130 may further determine, based on second guidance information of the plurality of candidate promoters, the at least one candidate promoter. The second guidance information indicates an amount of objects acquired via guidance contents published by the plurality of candidate promoters within a predetermined period of time, and the amount associated with the at least one candidate promoter is below a threshold amount. Furthermore, the computing device 130 may reduce the priority level of the at least one candidate promoter.

Taking the live streaming sales as an example, the second guidance information may represent, for example, an amount or a quantity (also known as sales volume) that a live streamer guides users to purchase goods within a predetermined period of time. The computing device 130 may, for example, reduce the priority levels of live streamers with sales volume below a threshold.

Furthermore, the computing device 130 may select and acquire a target promoter based on the adjusted priority level.

In some embodiments, the computing device 130 may further present information associated with the target promoter to the target provider. For example, the computing device 130 may send information associated with the target promoter to the target promoter, and such information may include, for example, a description about the target promoter.

Taking the live streaming sales as an example, the computing device 130 may provide information (for example, a level of the live streamer, the number of followers, a sales category, recent sales volume, contact information, and so on.) of a determined target live streamer to the target merchant. Such information may help the target merchant understand features of the target live streamer more conveniently, thereby promoting cooperation between both parties.

In some embodiments, the target promoter comprises a first promoter and a second promoter. The priority level of the first promoter is higher than the priority level of the second promoter, and first information associated with the first promoter has a higher presentation priority than second information associated with the second promoter.

For example, the computing device 130 may present information of a plurality of target promoters through a list, and enable information of target promoters with higher priority levels to be presented at the upper end of the list. It should be understood that the first information may be more prominently presented through other appropriate means.

It should be understood that any attributes or features mentioned above that involve a live streamer, a merchant, a user, or a follower should be acquired with permission from corresponding subjects.

Based on the process discussed above, the embodiments of the present disclosure may utilize feature engineering to determine the priority levels from the plurality of candidate promoters initially recalled, and thus can determine a suitable target promoter for a target provider more accurately, thereby increasing the possibility of further cooperation between the two parties.

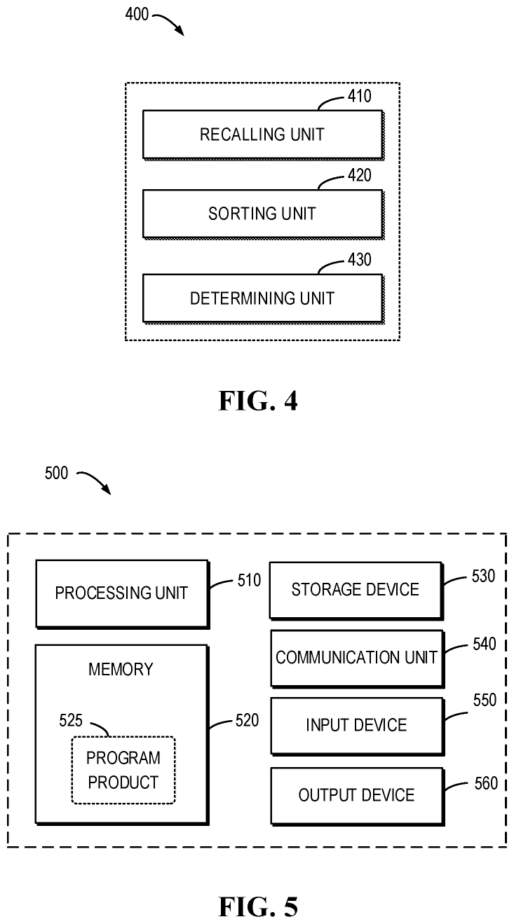

The embodiments of the present disclosure further provide corresponding apparatuses for implementing the above methods or processes. FIG. 4 illustrates a schematic structural block diagram of an apparatus for entity clustering 400 according to some embodiments of the present disclosure.

As shown in FIG. 4, the apparatus 400 may include a recalling unit 410 configured to recall, from a set of promoters, a plurality of candidate promoters for a target provider. The target provider is capable of providing at least one object available to a user. The plurality of candidate promoters are capable of publishing guidance contents for guiding a user to acquire a corresponding object. The apparatus 400 may further include a sorting unit 420 configured to determine, based on a first feature of the target provider and second features of the plurality of candidate promoters, priority levels of the plurality of candidate promoters. The apparatus 400 may further include a determining unit 430 configured to determine, based on the priority levels, a target promoter for the target provider from the plurality of candidate promoters.

In some embodiments, the recalling unit 410 may be further configured to determine, from the set of promoters, a plurality groups of candidate promoters corresponding to a plurality of recall policies; and select, from the plurality groups of candidate promoters, the plurality of candidate promoters.

In some embodiments, the plurality of recalling policies include a Field-aware Factorization Machines FFM recall policy, and the recalling unit 410 may be further configured to be an FFM unit. The FFM unit may be configured to determine a first field vector of the target provider and a second field vector of the plurality of promoters; and determine a group of candidate promoters base on a distance between the first field vector and the second field vector.

In some embodiments, the plurality of recall policies comprise a collaborative recall policy, and the recalling unit 410 may be further configured to: determine, based on historical cooperation information of the target provider, a historical promoter that has cooperated with the target provider; acquire a group of candidate promoters whose differences from the historical promoter are below a predetermined threshold.

In some embodiments, the plurality of recall policies comprise a contact establishment recall policy, and the recalling unit 410 may be also configured to determine, based on historical contact information of the target provider, a promoter that has previously been contacted by the target provider, to be a group of candidate promoters.

In some embodiments, the plurality of recall policies comprise a lookalike recall policy, and the recalling unit 410 may be further configured to determine, based on a group of seed users associated with the target provider, a group of expanded users. The group of seed users acquire an object provided by the target provider within a predetermined period of time. The recalling unit 410 may be further configured to acquire a promoter associated with the group of expanded users to be a group of candidate promoters.

In some embodiments, the plurality of recall policies comprise a popularity recall policy, and the recalling unit 410 may be further configured to determine a group of candidate promoters with a popularity exceeding a threshold. The popularity indicates a degree to which the promoter is concerned by a user.

In some embodiments, the plurality of recall policies comprise a similar object recall policy, and the recalling unit 410 may be further configured: to determine a group of similar objects whose differences from the at least one object are below a predetermined threshold; and acquire a promoter associated with the group of similar objects to be a group of candidate promoters.

In some embodiments, each of the plurality groups of candidate promoters has at most a threshold number of candidate promoters to be included in the selected plurality of candidate promoters.

In some embodiments, the recalling unit 410 may be further configured to exclude a self-broadcasting promoter from the plurality groups of candidate promoters to acquire the plurality of candidate promoters. The self-broadcasting promoter guides a user to acquire an object that is provided by the self-broadcasting promoter or an affiliate party of the self-broadcasting promoter within a predefined period of time.

In some embodiments, the first feature represents a user attribute of a first group of associated users associated with the target provider, and the second feature represents a user attribute of a second group of associated users associated with the candidate promoter.

In some embodiments, the first feature represents first statistical information associated with the target provider, the second feature represents second statistical information associated with the candidate promoter, at least one of the first statistical information and the second statistical information is updated in real-time or periodically in response to a user operation.

In some embodiments, the first feature represents a first attribute of a historical promoter that has cooperated with the target provider, the second feature represents a second attribute of a historical provider that has cooperated with the candidate promoter.

In some embodiments, the sorting unit 420 is further configured to: generate input features based on a first feature representation of the first feature and a second feature representation of the second feature; and process the input features using a priority model to determine a priority level. The priority model is trained based the historical cooperation information of a group of training providers and a group of training promoters.

In some embodiments, the determining unit 430 may be further configured to: adjust the priority level of at least one of the plurality of candidate promoters; and determine, based on the adjusted priority level, the target promoter.

In some embodiments, the determining unit 430 may be further configured to reduce the priority level of at least one candidate promoter that has previously cooperated with the target provider.

In some embodiments, the determining unit 430 may be further configured to determine, based on first guidance information of the at least one candidate promoter, a degree by which the priority level is reduced. The first guidance information indicates an amount of objects acquired via a guidance content published by the at least one candidate promoter within a predefined period of time. The determining unit 430 may be further configured to reduce the priority level based on the degree.

In some embodiments, the determining unit 430 may be further configured to determine a difference between first evaluation information of the plurality of candidate promoters and second evaluation information of a historical promoter. The historical promoter comprises a promoter that has previously cooperated with the target provider. The determining unit 430 may be further configured to adjust the priority level based on the difference such that a priority level of a candidate promoter with a difference greater than a threshold is reduced.

In some embodiments, the determining unit 430 may be further configured to determine, based on second guidance information of the plurality of candidate promoters, the at least one candidate promoter, wherein the second guidance information indicates an amount of objects acquired via guidance contents published by the plurality of candidate promoters within a predefined period of time, and the amount associated with the at least one candidate promoter is below a threshold amount; and reduce the priority level of the at least one candidate promoter.

In some embodiments, the apparatus 400 may further include a providing unit configured to present, to the target provider, information associated with the target promoter.

In some embodiments, the target promoter comprises a first promoter and a second promoter. The priority level of the first promoter is higher than the priority level of the second promoter, and first information associated with the first promoter has a higher presentation priority than second information associated with the second promoter

The units included in the apparatus 400 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all units in the apparatus 400 may be implemented at least partially by one or more hardware logic components. As an example, rather than a limitation, example types of hardware logic components that can be used include field programmable gate array (FPGA), application specific integrated circuit (ASIC), application specific standard (ASSP), system on chip (SOC), complex programmable logic device (CPLD), and so on.

FIG. 5 illustrates a block diagram of a computing device/server 500 in which one or more embodiments of the present disclosure may be implemented. It should be understood that the computing device/server 500 shown in FIG. 5 is only an example and should not constitute any limitation on the functionality and scope of the embodiments described herein.

As shown in FIG. 5, the computing device/server 500 is in the form of a general computing device. The components of the computing device/server 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes based on the programs stored in the memory 520. In a multiprocessor system, multiple processing units execute computer executable instructions in parallel to improve the parallel processing capability of the computing device/server 500.

The computing device/server 500 typically includes multiple computer storage medium. Such medium may be any available medium that is accessible to the computing device/server 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 530 may be any removable or non-removable medium, and may include a machine readable medium such as a flash drive, a disk, or any other medium, which can be used to store information and/or data (such as training data for training) and can be accessed within the computing device/server 500.

The computing device/server 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the computing device/server 500 may be implemented by a single computing cluster or multiple computing machines, which can communicate through a communication connection. Therefore, the computing device/server 500 may be operated in a networking environment using a logical connection with one or more other servers, a network personal computer (PC), or another network node.

The input device(s) 550 may be one or more input devices, such as a mouse, a keyboard, a trackball, and so on. The output device(s) 560 may be one or more output devices, such as a display, a speaker, a printer, and so on. The computing device/server 500 may also communicate with one or more external devices (not shown) through the communication unit 540 as required. The external device, such as a storage device, a display device, and so on, communicate with one or more devices that enable users to interact with the computing device/server 500, or communicate with any device (for example, a network card, a modem, and so on.) that makes the computing device/server 500 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above.

Various aspects of the present disclosure are described herein with reference to the flow chart and/or the block diagram of the method, the apparatus (system) and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of promoter determination, comprising:
recalling, from a set of promoters, a plurality of candidate promoters for a target provider, the target provider being capable of providing at least one object available to a user, the plurality of candidate promoters being capable of publishing guidance contents for guiding a user to acquire a corresponding object;
determining, based on a first feature of the target provider and second features of the plurality of candidate promoters, priority levels of the plurality of candidate promoters; and
determining, based on the priority levels, a target promoter for the target provider from the plurality of candidate promoters.

2. The method of claim 1, wherein recalling, from a set of promoters, a plurality of candidate promoters for a target provider comprises:
determining, from the set of promoters, a plurality groups of candidate promoters corresponding to a plurality of recall policies; and
selecting, from the plurality groups of candidate promoters, the plurality of candidate promoters.

3. The method of claim 2, wherein the plurality of recall policies comprise a collaborative recall policy, and determining a plurality groups of candidate promoters corresponding to a plurality of recall policies comprises:
determining, based on historical cooperation information of the target provider, a historical promoter that has cooperated with the target provider;
acquiring a group of candidate promoters whose differences from the historical promoter are below a predetermined threshold.

4. The method of claim 2, wherein the plurality of recall policies comprise a lookalike recall policy, and determining a plurality groups of candidate promoters corresponding to a plurality of recall policies comprises:
determining, based on a group of seed users associated with the target provider, a group of expanded users, the group of seed users acquiring an object provided by the target provider within a predetermined period of time; and
acquiring a promoter associated with the group of expanded users to be a group of candidate promoters.

5. The method of claim 2, wherein the plurality of recall policies comprise a similar object recall policy, and determining a plurality groups of candidate promoters corresponding to a plurality of recall policies comprises:
determining a group of similar objects whose differences from the at least one object are below a predetermined threshold; and
acquiring a promoter associated with the group of similar objects to be a group of candidate promoters.

6. The method of claim 2, wherein each of the plurality groups of candidate promoters has at most a threshold number of candidate promoters to be included in the selected plurality of candidate promoters.

7. The method of claim 2, wherein selecting, from the plurality groups of candidate promoters, the plurality of candidate promoters comprises:
excluding a self-broadcasting promoter from the plurality groups of candidate promoters to acquire the plurality of candidate promoters, the self-broadcasting promoter guiding a user to acquire an object that is provided by the self-broadcasting promoter or an affiliate party of the self-broadcasting promoter within a predetermined period of time.

8. The method of claim 1, wherein the first feature represents a user attribute of a first group of associated users associated with the target provider, and the second feature represents a user attribute of a second group of associated users associated with the candidate promoter.

9. The method of claim 1, wherein the first feature represents first statistical information associated with the target provider, the second feature represents second statistical information associated with the candidate promoter, at least one of the first statistical information and the second statistical information is updated in real-time or periodically in response to a user operation.

10. The method of claim 1, wherein the first feature represents a first attribute of a historical promoter that has cooperated with the target provider, the second feature represents a second attribute of a historical provider that has cooperated with the candidate promoter.

11. The method of claim 1, wherein determining a target promoter for the target provider from the plurality of candidate promoters comprises:
adjusting the priority level of at least one of the plurality of candidate promoters; and
determining, based on the adjusted priority level, the target promoter.

12. The method of claim 11, wherein adjusting the priority level of at least one of the plurality of candidate promoters comprises:
reducing the priority level of at least one candidate promoter that has previously cooperated with the target provider.

13. The method of claim 12, wherein reducing the priority level of at least one candidate promoter comprises:
determining, based on first guidance information of the at least one candidate promoter, a degree by which the priority level is reduced, the first guidance information indicating an amount of objects acquired via a guidance content published by the at least one candidate promoter within a predetermined period of time; and
reducing the priority level based on the degree.

14. The method of claim 11, wherein adjusting the priority level of at least one of the plurality of candidate promoters comprises:
determining a difference between first evaluation information of the plurality of candidate promoters and second evaluation information of a historical promoter, the historical promoter comprising a promoter that has previously cooperated with the target provider; and
adjusting the priority level based on the difference such that a priority level of a candidate promoter with a difference greater than a threshold is reduced.

15. The method of claim 11, wherein adjusting the priority level of at least one of the plurality of candidate promoters comprises:
determining, based on second guidance information of the plurality of candidate promoters, the at least one candidate promoter, wherein the second guidance information indicates an amount of objects acquired via guidance contents published by the plurality of candidate promoters within a predetermined period of time, and the amount associated with the at least one candidate promoter is below a threshold amount; and
reducing the priority level of the at least one candidate promoter.

16. The method of claim 1, further comprising:
presenting, to the target provider, information associated with the target promoter,
wherein the target promoter comprises a first promoter and a second promoter, the priority level of the first promoter is higher than the priority level of the second promoter, and first information associated with the first promoter has a higher presentation priority than second information associated with the second promoter.

17-20. (canceled)

21. An electronic device, comprising:
a memory and a processor;
wherein the memory is used to store one or more computer instructions, and the one or more computer instructions are executed by the processor to implement a method of promoter determination, the method comprises:
recalling, from a set of promoters, a plurality of candidate promoters for a target provider, the target provider being capable of providing at least one object available to a user, the plurality of candidate promoters being capable of publishing guidance contents for guiding a user to acquire a corresponding object;
determining, based on a first feature of the target provider and second features of the plurality of candidate promoters, priority levels of the plurality of candidate promoters; and
determining, based on the priority levels, a target promoter for the target provider from the plurality of candidate promoters.

22. The electronic device according to claim 21, wherein recalling, from a set of promoters, a plurality of candidate promoters for a target provider comprises:
determining, from the set of promoters, a plurality groups of candidate promoters corresponding to a plurality of recall policies; and
selecting, from the plurality groups of candidate promoters, the plurality of candidate promoters.

23. The electronic device according to claim 22, wherein the plurality of recall policies comprise a collaborative recall policy, and determining a plurality groups of candidate promoters corresponding to a plurality of recall policies comprises:
determining, based on historical cooperation information of the target provider, a historical promoter that has cooperated with the target provider;
acquiring a group of candidate promoters whose differences from the historical promoter are below a predetermined threshold.

24. A non-transitory computer-readable storage medium, storing thereon one or more computer instructions, wherein the one more computer instructions are executed by a processor to implement a method of promoter determination, the method comprises:
recalling, from a set of promoters, a plurality of candidate promoters for a target provider, the target provider being capable of providing at least one object available to a user, the plurality of candidate promoters being capable of publishing guidance contents for guiding a user to acquire a corresponding object;
determining, based on a first feature of the target provider and second features of the plurality of candidate promoters, priority levels of the plurality of candidate promoters; and
determining, based on the priority levels, a target promoter for the target provider from the plurality of candidate promoters.
